(19) United States
(12) Patent Application Publication
(10) Pub. No.: US 2005/0039708 A1
(43) Pub. Date: Feb. 24, 2005

(54) Piston exhaust system

(76) Inventor: William Delaplaine Green, Bethlehem, PA (US)

Correspondence Address: WILLIAM DELAPLAINE GREEN, 8906 CAMDEN ST., ALEXANDRIA, VA, 22308, US

(21) Appl. No.: 10/949,468

(22) Filed: Sep. 27, 2004

Related U.S. Application Data
(63) Continuation-in-part of application No. 10/637,841, filed on Aug. 8, 2003.
(60) Provisional application No. 60/505,747, filed on Sep. 26, 2003.

(51) Int. Cl. F02B 33/00

(52) U.S. Cl. 123/68

(57) ABSTRACT

A piston exhaust assembly includes a center exhaust valve port surrounding a center exhaust valve. The exhaust valve stem rests on a cam lobe formed on the top of the connecting rod. Reciprocating rotation of the connecting rod rotates the cam lobe under the exhaust valve stem opening the exhaust valve before the piston reaches BDC and exhaust gases flow through piston exhaust passages into the wrist pin center hole which serves as an exhaust gas outlet hole and out of the engine through an exhaust port formed in the cylinder wall. The piston exhaust valve opens before closes after the piston reaches TDC. A combustion operated valve face covers the piston exhaust port during piston travel from TDC to BDC until the piston exhaust valve closes preventing any loss of power which would occur by the escape of high pressure cylinder combustion gases formed during the power stroke of the engine flowing into an open piston exhaust port.

### PREAMBLE

This patent application is referenced to provisional patent application 60/505,747 filed Sep. 26, 2003.

### INTRODUCTION

The present disclosure pertains to a two cycle internal combustion engine patented Apr. 15, 2003. A conventional piston design was used in one embodiment of that engine which had a convention exhaust port formed in the side of the cylinder of the engine. That design did not show any means to completely or nearly completely remove the exhaust from the cylinder after the power stroke of the engine without using compressed air to scavenge the cylinder. The present invention shows a means to remove almost all of the exhaust from the cylinder after the power stroke of the engine.

### BACKGROUND OF THE INVENTION

In conventional two cycle internal combustion engines conventional pistons are used. Although many unconventional designs are known in the art that have a valve located in the piston I know of no designs that use a cam lobe formed on the piston connecting rod as a means to open a valve located in the piston. The present design discloses a connecting rod with a cam type lobe formed on it to push open a valve located in the center of the top of the piston. Many piston designs known in the art show pistons having side exhaust ports formed in the piston to pass exhaust gases out of the piston but I know of no piston designs that use a hollow wrist pin which connects the piston to the connecting rod as a exhaust gas outlet hole through which to pass exhaust out of the piston.

### SUMMARY OF THE INVENTION

The invention comprises a piston, rod and valve assembly. A poppet valve in the top of the piston is opened by the movement of the connecting rod and lets exhaust gases flow out of the cylinder as the piston nears bottom dead center. The exhaust gases flow into a center piston exhaust port, through the top half of the piston and into exhaust inlets in the piston wrist pin. The exhaust flows through the hollow wrist pin to one side of the piston as it slides up and down against the cylinder wall. A vertical elongated exhaust port is formed in the cylinder wall (not shown) and the exhaust gases flowing out of the piston wrist pin exhaust gas outlet hole flow into the cylinder exhaust port and out of the engine. The outer surface of the piston skirt(s) covers the cylinder exhaust port(s) preventing the seepage of crankcase oil lubricating the cylinder walls into the cylinder exhaust port(s). The piston exhaust valve opens before BDC and remains open until after TDC so all the exhaust gases inside the cylinder can flow out of the cylinder. The piston is designed to be used with a combustion operated intake valve described and illustrated in my U.S. Pat. No. 6,546,901 so the piston exhaust port is covered by the combustion operated intake valve face during the pistons downward movement after TDC and remains covered by the combustion operated intake valve face until the piston exhaust valve has closed.

### BRIEF DESCRIPTION OF THE DRAWINGS (SUBMITTED WITH PRELIMINARY DRAWINGS)

FIG. 1 is a wire frame top view of a piston, valve and rod assembly in accordance with one embodiment of the invention.

FIG. 2 is a wire frame front view of the piston, valve and rod assembly shown in FIG. 1.

FIG. 3 is a wire frame side view of the piston, valve and rod assembly shown in FIG. 1.

FIG. 4 is a wire frame orthographic view of the piston, valve and rod assembly shown in FIG. 1.

FIG. 5 is a wire frame top view of the piston shown in FIG. 1.

FIG. 6 is a wire frame front view of the piston shown in FIG. 1.

FIG. 7 is a wire frame side view of the piston shown in FIG. 1.

FIG. 8 is a wire frame orthographic view of the piston shown in FIG. 1.

FIG. 9 is a wire frame top view of the wrist pin shown in FIG. 1.

FIG. 10 is a wire frame front view of the wrist pin shown in FIG. 1.

FIG. 11 is a wire frame side view of the wrist pin shown in FIG. 1.

FIG. 12 is a wire frame orthographic view of the wrist pin shown in FIG. 1.

FIG. 13 is a wire frame top view of the connecting rod shown in FIG. 1.

FIG. 14 is a wire frame front view of the connecting rod shown in FIG. 1.

FIG. 15 is a wire frame side view of the connecting rod shown in FIG. 1.

FIG. 16 is a wire frame orthographic view of the connecting rod shown in FIG. 1.

FIG. 17 is a wire frame top view of the valve, spring, retainer, keeper assembly shown in FIG. 1.

FIG. 18 is a wire frame front view of the valve, spring, retainer, keeper assembly shown in FIG. 1.

FIG. 19 is a wire frame side view of the valve, spring, retainer, keeper assembly shown in FIG. 1.

FIG. 20 is a wire frame orthographic view of the valve, spring, retainer, keeper assembly shown in FIG. 1.

### DESCRIPTION OF THE PREFERRED EMBODIMENT

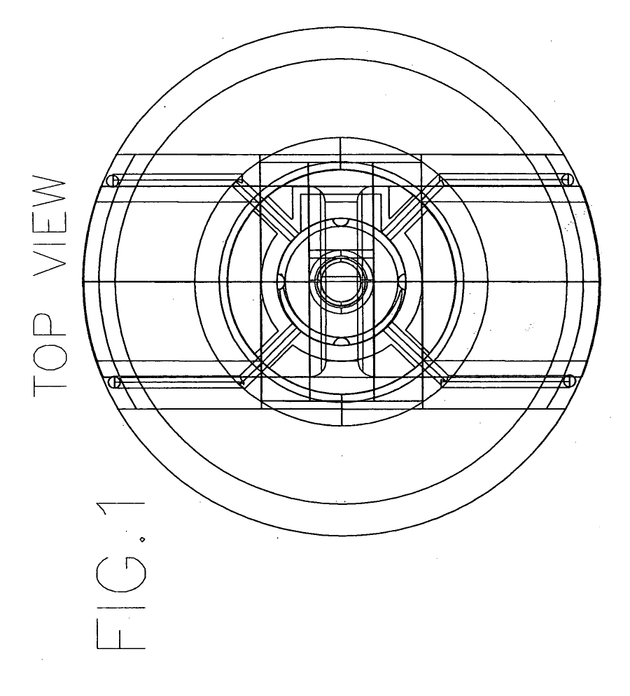

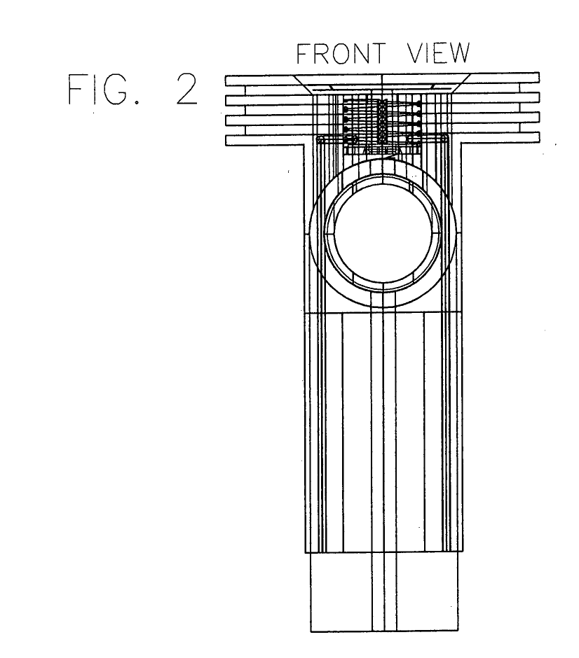

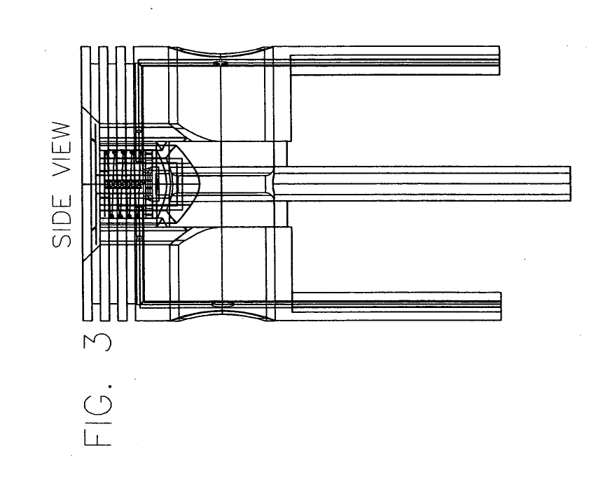

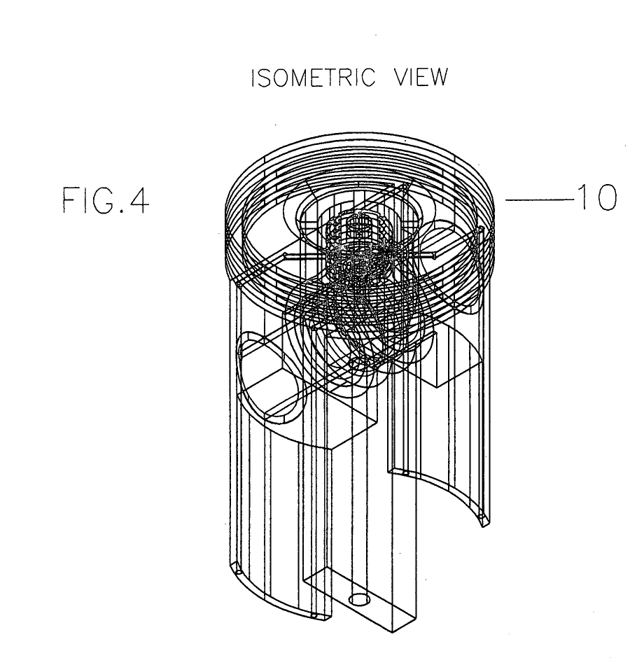

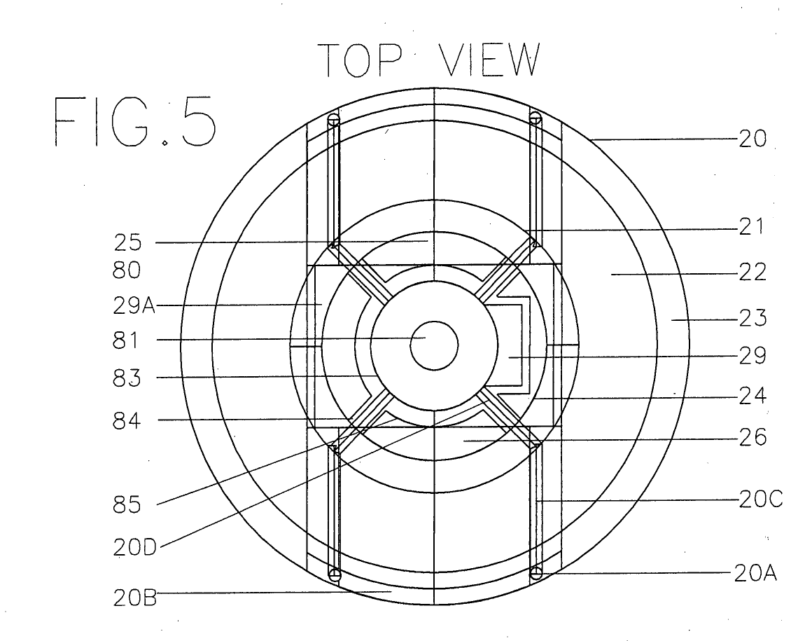

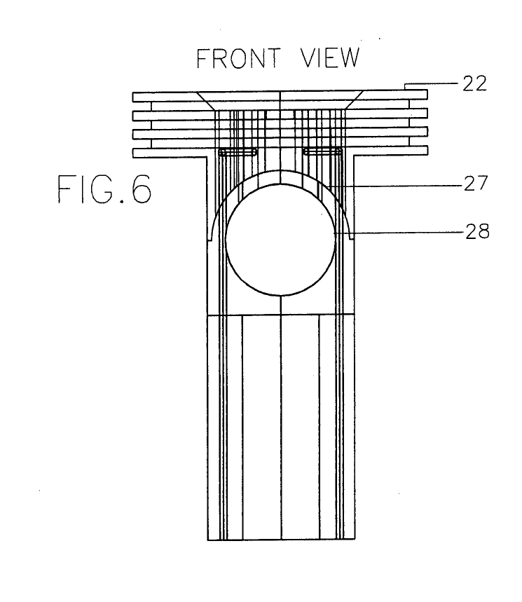

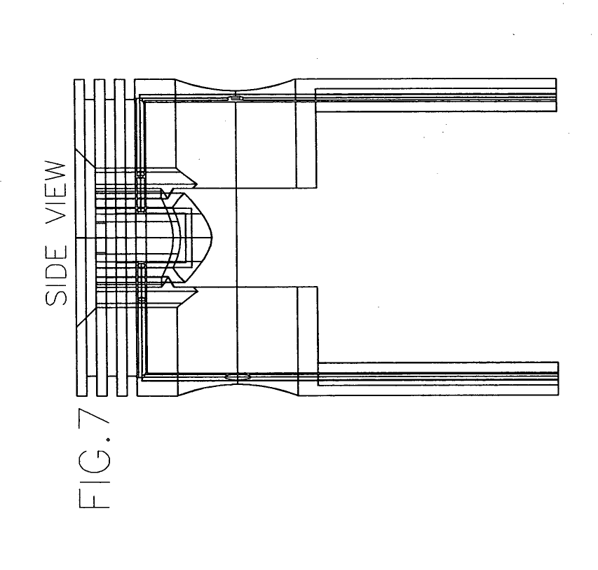

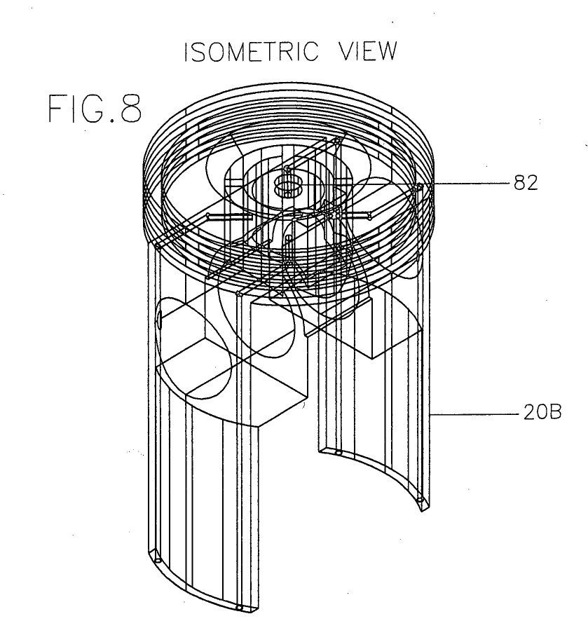

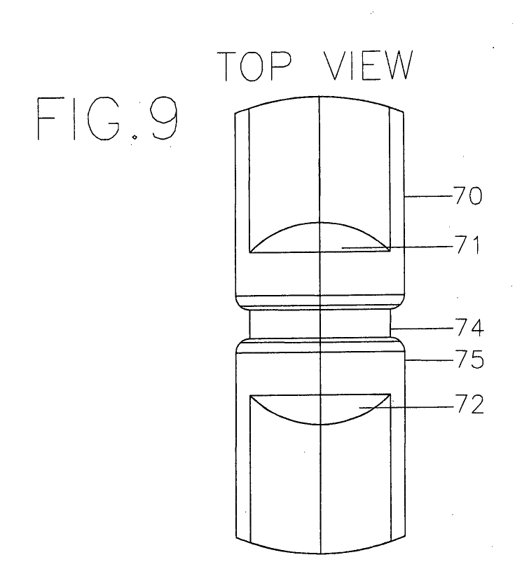

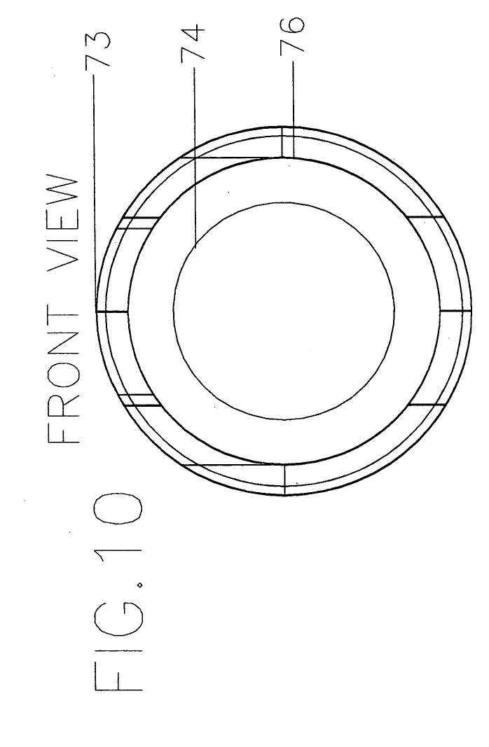

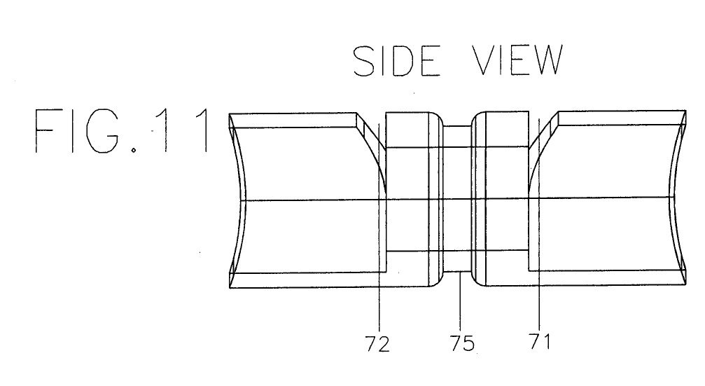

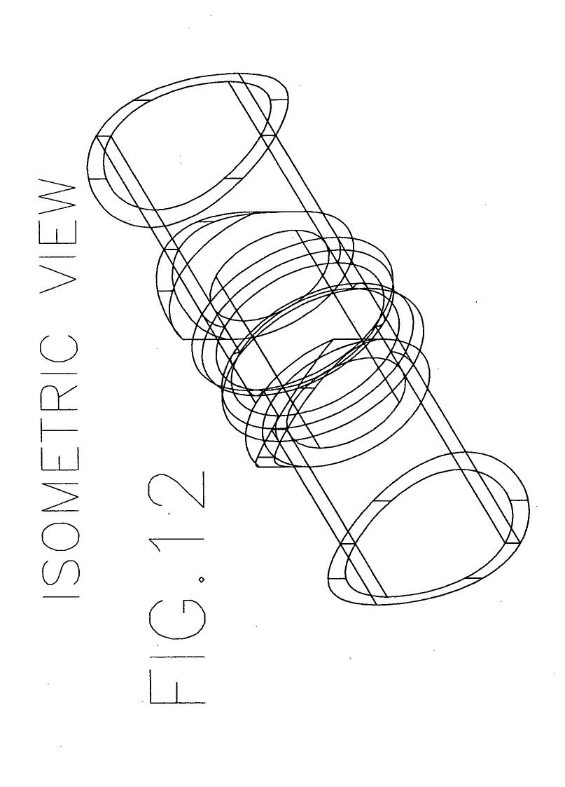

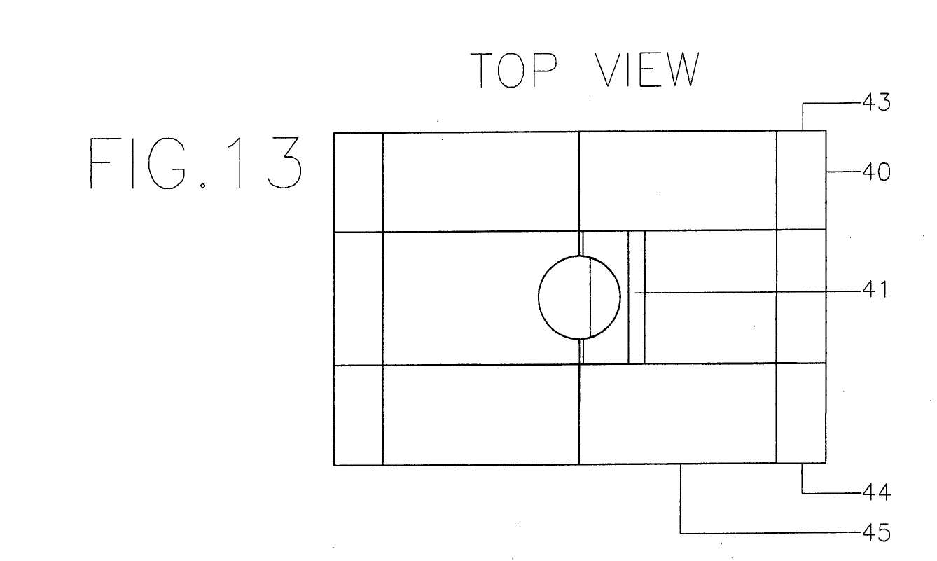

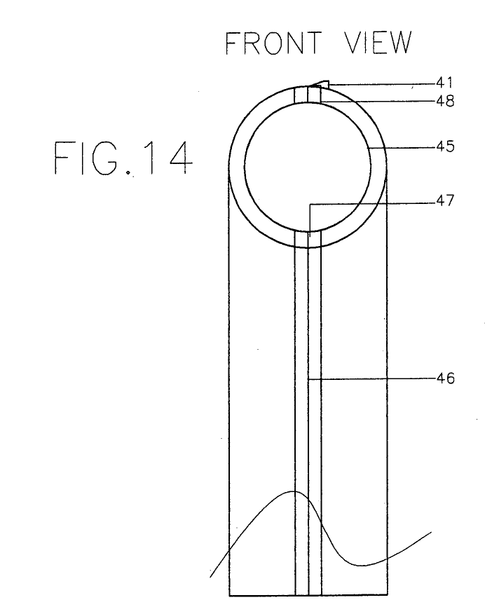

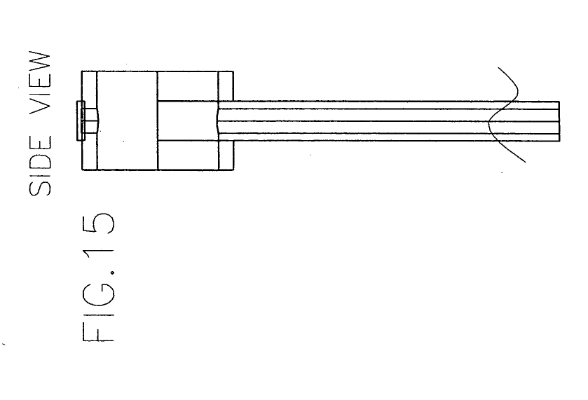

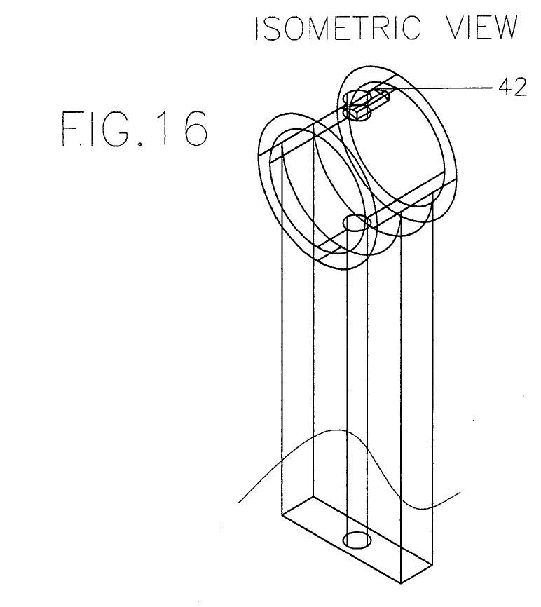

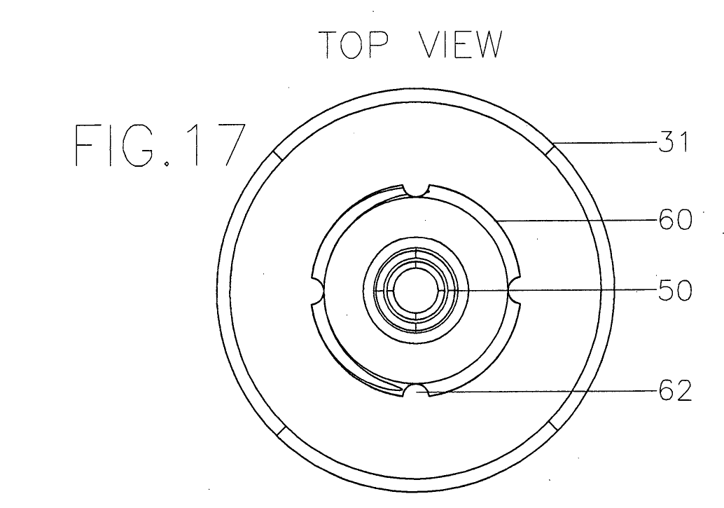

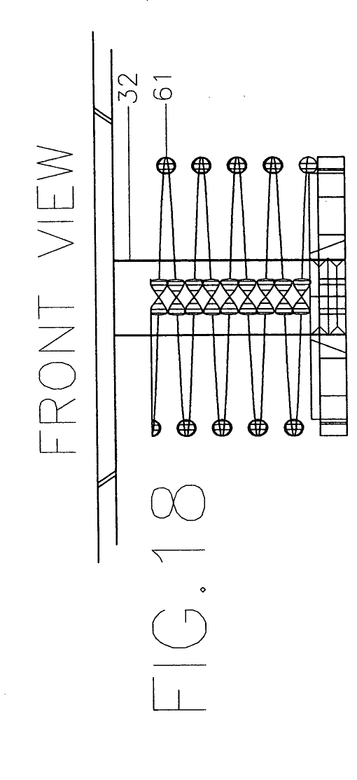

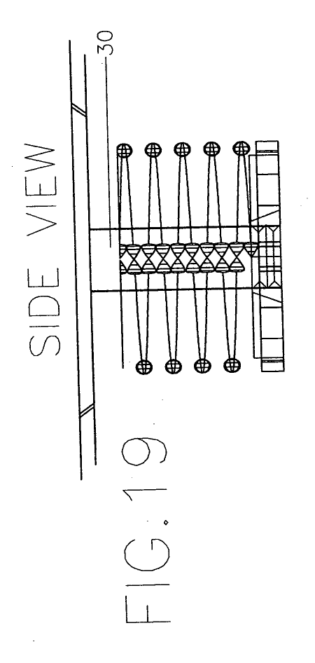

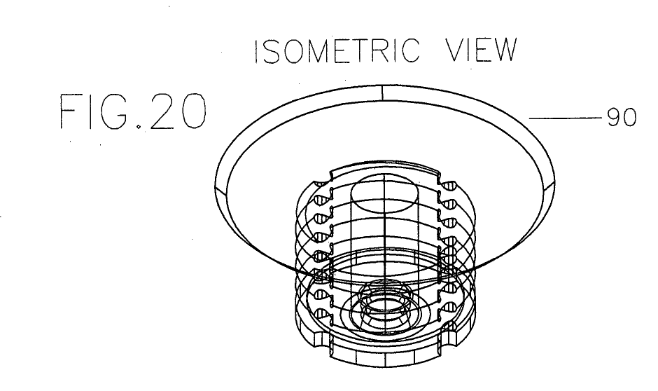

The invention comprises a piston 20, a connecting rod 40 and a exhaust valve 30 assembly generally referred to by reference number 10 illustrated in FIG. 4. As illustrated in FIGS. 1-20 the simplest embodiment of the piston 20, FIG. 8, has a piston face 22 in which is formed a exhaust valve port 21 which extends to a piston wrist pin hole 28. Shown in FIGS. 4, 9-2 a wrist pin 70, which extends from one side of the piston 20 to the other side inside of piston wrist pin hole 28, has two exhaust inlet ports 71 and 72 formed in a upper side 73 and a internal center hole 74 formed within a exhaust gas outlet hole 76 extending from one end of the wrist pin 70. FIG. 5 shows a exhaust valve spring container cup 80 which has a cup center valve stem hole 81 formed in a cup upper wall 82, FIG. 8, and four cup support arms 84 extending outward from a cup outer wall 85 FIG. 5. The exhaust valve head 31 is recessed into the piston face 22 inside of a exhaust valve port 21. Piston skirts 20B, FIG.8, extend the length of the piston and contain oil passages 20A. The exhaust valve 30, FIG. 19, a exhaust valve spring 61, the exhaust valve spring retainer 60, and a exhaust valve retainer keeper 50 form a exhaust valve assembly 90, FIG. 20, mounted inside the piston 20 and the exhaust valve spring retainer cup 80 so a exhaust valve stem 32, FIG. 16, rests upon a connecting rod wrist pin end 42 and projects through the cup center valve stem hole 81, FIG. 4. Formed on the connecting rod wrist pin end 42 is a cam type valve actuation lobe 41. Valve actuation lobe 41 rotates within a piston lobe compartment 29 which seals against the connecting rod wrist pin end 42 sealing the valve actuation system from exhaust gases. A connecting rod oil hole 46 connects to a connecting rod wrist pin hole oil 47 and a valve actuation lobe oil hole 48, FIG. 14. Piston lobe compartment 29 connects to a exhaust valve spring retainer oil hole 62, FIG. 17, which connects to the exhaust valve spring retainer cup 80. A valve head 31 rests upon the top cup upper wall 82 and rests upon a exhaust valve seat 29A, FIG. 5, surrounding the top of exhaust valve port 21 in piston 20. A piston exhaust passage 25 and a piston exhaust passage 26 are formed inside the piston 20 and connect the piston exhaust valve port 21 to the wrist pin exhaust ports 71 and 72. Piston ring grooves 23 are formed around the piston to accept piston rings. The connecting rod wrist pin end 42 is circular with a flat side 43 and a opposite flat side 44 and fits into a piston connecting rod hole 27 formed to closely confine the flat sides 43 and 44 and the circular connecting rod wrist pin end 42 to prevent the escape of exhaust gases into the crankcase (not shown) FIGS. 6 & 13. Wrist pin 70 is pressed fit into piston wrist pin hole 28 passing through a rotatably connected rod wrist pin hole 45, FIG. 14. Cup support arm oil holes 20D connect the exhaust valve retainer cup to piston top oil holes 20C that connect to piston skirt oil holes 20A, FIG. 5. The connecting rod 40 is connected to a conventional crankshaft (not shown) in a convention way (not shown).

During operation of the engine the rotation of the crankshaft moves the connecting rod crankshaft crank journal end (not shown) from side to side causing the connecting rod wrist pin end 42 to reciprocate back and forth around the wrist pin 70. As the piston moves from TDC to BDC the reciprocating motion of the connecting rod wrist pin end 42 moves the valve actuation lobe 41 out of contact with the valve retainer 60 closing the exhaust valve 30. When the piston 20 approaches BDC the reciprocating motion of the connecting rod wrist pin end 42 moves the valve actuation lobe 41 into contact with the valve spring retainer 60 opening the exhaust valve 30 by compressing the exhaust valve spring 61 and forcing the exhaust valve retainer keeper 50 to force the exhaust valve stem 32 upwards through the cup center valve stem hole lifting the exhaust valve head 31 off the exhaust valve seat 29A. As exhaust valve 30 opens exhaust gases within the cylinder (not shown) pass into the piston upper exhaust port 25 and flow through exhaust valve port 21 passing into piston exhaust passages 25 and 26. Exhaust gases flowing through piston exhaust passages 25 and 26 enter wrist pin exhaust inlets 71 and 72 and pass into and through wrist pin center hole 75 flowing out one end of the wrist pin 70 through the exhaust gas outlet hole 76. Exhaust flowing out of the exhaust gas outlet hole 76 flow into the cylinder exhaust port (not shown). As the crankshaft rotates and the piston 20 travels from BDC to TDC the exhaust valve 30 is held open by the valve actuation lobe 41 which rotates into and out of the piston lobe compartment 29 and exhaust gases inside the cylinder (not shown) are forced by the upward movement of the piston 20, which thereby reduces the volume within the cylinder, to flow through the piston 20 and wrist pin 70 out through the cylinder exhaust port. The piston exhaust valve 30 remains open a few degrees after TDC. No combustion gases can enter the exhaust port 21 during downward travel of the piston from TDC to BDC because a combustion operated intake valve face (not shown) covers the exhaust port 21 until the exhaust valve 30 has closed. Oil is pumped by the engine oil pump (not shown) through connecting rod oil holes 46, 47 and 48 and valve spring retainer oil hole 62 to lubricate the connecting rod, wrist pin, valve actuation lobe, valve spring assembly, and valve spring container cup. Oil flows through the exhaust valve spring retainer cup into support arm oil holes 20D flowing through them into piston top oil holes 20C. Oil flowing through piston top oil holes 20C flow into piston skirt oil holes 20A and flow out of the piston back into the crankcase (not shown). A cam plate instead of a connecting rod cam lobe and valve spring assembly may be used to actuate the exhaust valve thereby eliminating the need for a valve spring assembly although this system is not shown.

While the preferred embodiment of the invention has been shown and described, it is to be understood that the disclosure is for the purpose of illustration and that various changes and modifications may be made without departing from the scope of the invention as set forth in the appended claims.

### Parts—Piston Exhaust System

10 piston, rod and valve assembly
20 piston
20A piston skirt oil holes
20B piston skirt
20C piston top oil holes
20D cup support arm oil holes
21 piston exhaust valve port
22 piston face
23 piston ring grooves
24 piston exhaust valve port wall
25 piston exhaust passage
26 piston exhaust passage
27 piston connecting rod hole
28 piston wrist pin hole
30 exhaust valve
31 exhaust valve head
32 exhaust valve stem
40 connecting rod
41 connecting rod valve actuation lobe
42 connecting rod wrist pin end
43 connecting rod wrist pin end flat side
44 connecting rod wrist pin end flat side
45 connecting rod wrist pin hole
46 connecting rod oil hole
50 exhaust valve retainer keeper
60 exhaust valve retainer
61 exhaust valve spring
62 exhaust valve spring retainer oil hole
70 wrist pin
71 wrist pin exhaust inlet port
72 wrist pin exhaust inlet port
73 wrist pin upper side
74 wrist pin internal center hole
75 wrist pin center groove
76 exhaust gas outlet hole
80 exhaust valve spring retainer cup
81 cup center valve stem hole
82 cup upper wall
83 cup valve spring hole
84 cup support arms
85 cup outer wall
90 exhaust valve assembly

1. In a internal combustion engine the method of:
A. Opening and closing a valve confined within a piston by motion of the connecting rod,
B. Passing exhaust gases through exhaust ports and exhaust passages within the piston to an exhaust gas outlet hole,

2. The improvement as defined in claim 1 wherein said piston exhaust gas outlet hole is the wrist pin center hole.
